(19) United States
(12) Patent Application Publication
(10) Pub. No.: US 2024/0072257 A1
(43) Pub. Date: Feb. 29, 2024

(54) LITHIUM IRON PHOSPHATE (LFP) CATHODE ACTIVE MATERIALS AND METHOD FOR DEPOSITION OF THE SAME

(71) Applicant: QPIVOLTA TECHNOLOGIES PRIVATE LIMITED, Bangalore (IN)

(72) Inventors: MANJUNATH GANGAIAH, Ramnagara (IN); NAWAF ALAMPARA, Kerala (IN); ASWANTH KRISHNAN, Kerala (IN); PINAKIN MANSUKHLAL PADALIA, Rajkot (IN); NAGENDRA NAGARAJA, Bangalore (IN)

(21) Appl. No.: 18/454,643

(22) Filed: Aug. 23, 2023

(30) Foreign Application Priority Data
Aug. 23, 2022 (IN) 202241048074

(51) Int. Cl. H01M 4/58; C01G 49/00; H01M 4/04; H01M 4/136; H01M 4/1397; H01M 4/62; H01M 4/66

(52) U.S. Cl. CPC H01M 4/5825; C01G 49/009; H01M 4/0404; H01M 4/0471; H01M 4/136; H01M 4/1397; H01M 4/622; H01M 4/661; H01M 2004/028

(57) ABSTRACT

The embodiments herein provide lithium iron phosphate (LFP) cathode active materials and a method for deposition of the LFP active materials on an aluminum-foil current collector for lithium-ion (Li-ion) batteries. The embodiments herein utilize an aqueous based LFP precursor slurry made using combustion chemistry, where the LFP precursor slurry is composed of a redox mixture of the nitrates of lithium and iron, dihydrogen ammonium phosphate and glycine in water in the presence of flora-based sodium-carboxy methylcellulose as an organic binder. Furthermore, the thick and transparent precursors slurry is deposited on the aluminum current collector followed by annealing at appropriate pressures and atmospheric conditions. Therefore, the heat liberated in the exothermic reaction of the redox mixture not only assists in the formation of LFP cathode active materials, but also in the incineration of the organic binders and the solvent.

### CROSS-REFERENCE TO RELATED APPLICATIONS

The embodiments herein claim the priority of the Indian Provisional Patent Application (PPA) with serial number 202241048074 filed on Aug. 24, 2022, with the title “LITHIUM IRON PHOSPHATE (LFP) CATHODE ACTIVE MATERIALS AND METHOD FOR DEPOSITION OF THE SAME”. The contents of the abovementioned PPA are included in entirety as reference herein

### BACKGROUND

### Technical Field

The embodiments herein generally relate to the field of material science. The embodiments herein are particularly related to an energy storage device such as lithium-ion batteries. The embodiments herein are more particularly related to Lithium iron phosphate (LFP) cathode active material and the method for deposition of LFP cathode active materials (CAMs) on an aluminum-foil current collector, which forms an integral step in the manufacturing of simple and cost-effective lithium-ion batteries.

### Description of the Related Art

With the increasing demands for second-generation batteries, Li-ion batteries (LIBs) are emerging as a promising energy storage technology due to their high energy densities/charge capacities, low self-discharging property, good cycling capability, long lifespan, etc. These LIBs are considered to be one of the best power sources for portable electronic devices, electric vehicles (EVs) and hybrid electric vehicles (HEVs), etc. Also, the demand for film-type Li-ion batteries has spiked due to the tendency toward miniaturization of electronic circuit boards. The development of film-type batteries substantially expands its applications in modern miniature devices such as medical implants, memory units, smart cards, various sensors and converters, etc. Lithium ferrous phosphate, LiFeO₄ (LFP) has grabbed great attention due to its potential use as a cathode active material (CAMs) in LIBs. It has advantages over other CAMs such as a relatively high theoretical specific capacity of 170 mAhg¹, a high operating discharge potential of about 3.5 V vs Li⁺/Li, and excellent electrochemical stability. Even Li₃Fe₂(PO₄)₃ is also being used as CAMs, which have a discharge potential of 2.8 V and a theoretical specific capacity of 120 mAhg⁻¹. LFP CAMs possess high thermal stability, low cost, and low toxicity due to the presence of environmentally benign elements such as Iron (Fe). Moreover, covalently bonded PO₄³⁻ makes these LFP CAMs relatively better in terms of safety.

One of the main challenges in the process of making batteries is the synthesis of efficient cathode materials and depositing the same on the aluminum (Al) current collector. The conventional method is time-consuming and not-economical with multiple energy-demanding steps required in the process. Moreover, it also underutilizes resources and leads to wastage. FIG. 1 illustrates a block diagram of the conventional fabrication method of LFP cathodes from the precursors for Li-ion batteries. The process 100 comprises the steps of selecting the appropriate precursors for Lithium 101, Iron 102, and Phosphorous 103. The precursors are selected from the group consisting of acetates, nitrates, hydroxides, sulfates, and/or carbonates in the case of lithium 101. In the case of phosphorus 103, the precursors are selected from the group consisting of phosphoric acids, dihydrogen ammonium phosphates, etc. In the case of iron 102, the precursors are selected from the group consisting of nitrates, sulfates, acetates, acetylacetonates, phosphates, etc. Furthermore, the precursors are processed to synthesize LFP particles 104. Hence, the process for synthesizing LFP particles can be one of many possible methods such as: solid state reaction, hydrothermal/solvothermal synthesis, freeze drying, template direct, spray-drying, Co-precipitation, Sol-gel method, Solution combustion synthesis, etc. Once, the synthesizing of the LFP particles is completed, the particles are made to undergo post-processing in the form of procedures such as calcination, annealing, sintering etc., at elevated temperatures. The obtained particles, which are the processed LFP particles 105 are further mixed with organic binders and solvents to obtain a particle-based slurry 106. The obtained particle-based slurry 106 is then coated on an aluminium foil 107 current collector by using an appropriate method such as blade coating, slot die coating, spray coating, screen printing, etc. The obtained LFP particle-based film on aluminium is next annealed at a suitable temperature to remove organic binders and solvents 108. Therefore, the aforementioned method involves steps such as synthesis, preparation of LFP particle slurry, and deposition. Moreover, frequent annealing is employed for calcination and incineration of organic binders and solvents, which makes the entire process time-consuming and expensive.

To further elaborate on the steps involved in the prior art, FIG. 2 summarizes the conventional method in a flow chart manner. At step 201, the lithium precursor being used for the LFP synthesis is selected from the group consisting of lithium acetates, lithium nitrates, lithium hydroxides, lithium sulfates, lithium carbonates, etc. The phosphorous precursor is selected from the group consisting of phosphoric acids dihydrogen ammonium phosphates, etc. The precursor of iron is selected from the group consisting of ferrous nitrates, ferrous sulfates, iron acetates, iron (III) acetylacetonate, iron phosphates, etc. Furthermore, at step 202, a suitable method is adopted for the synthesis of LFP particles using chosen precursors of lithium, iron, and phosphorous 203. Various methods are available for the synthesis of LFP particles such as solid-state reaction, hydrothermal/solvothermal synthesis, freeze drying, template direct, spray-drying, Co-precipitation, Sol-gel method, Solution combustion synthesis, etc. 203. Furthermore, at step 204, the as-synthesized LFP particles undergo post-processing activities such as calcination, annealing, sintering etc. at elevated temperatures. Besides, at step 205, LFP particle slurry is prepared by mixing the appropriate quantities of synthesized LFP particles in an organic vehicle comprising organic binders and solvents. Further at step 206, LFP particle slurry is deposited on the Al-foil current collector using blade coating, slot die coating, spray coating, screen printing, etc. Finally, at step 207, the as-deposited LFP particle-based film is annealed at a suitable temperature to remove organic binders and solvents. Therefore, the conventional method described is expensive and time-consuming. Moreover, the conventional method also produces a lot of waste.

Hence, in view of this, there is a need for a clean, cheaper, and faster method for manufacturing LFP cathode for lithium-ion batteries by utilizing bio-degradable binders, which makes the entire manufacturing process environmental-friendly.

The above-mentioned shortcomings, disadvantages and problems are addressed herein, and which will be understood by reading and studying the following specification.

### OBJECTIVES OF THE EMBODIMENTS HEREIN

The primary object of the embodiments herein is to provide lithium iron phosphate (LFP) cathode active materials and a method for deposition of the LFP cathode active materials on a conductive current collector, such as an aluminium foil for lithium-ion (Li-ion) batteries.

Another object of the embodiments herein is to provide a simple and cost-effective method for developing eco-friendly LFP cathodes for lithium-ion batteries in high volume.

Yet another object of the embodiments herein is to provide a method and a system for identifying developers automatically.

Yet another object of the embodiments herein is to provide a method for the fabrication of LFP cathodes in high volume with less wastage of raw materials by bypassing and eliminating the energy-demanding steps involved in the conventional cathode fabrication method.

Yet another object of the embodiments herein is to provide a method that comprises the preparation of aqueous-based LFP precursor slurry using combustion chemistry and deposition of the LFP precursor slurry on the Al-foil current collector followed by annealing under an inert atmosphere.

Yet another object of the embodiments herein is to provide a method for deposition of the LFP cathode active materials on an aluminium foil current collector for lithium-ion (Li-ion) batteries by utilizing precursors such as nitrates of lithium, nitrates of iron, and phosphoric acid or dihydrogen ammonium phosphates.

Yet another object of the embodiments herein is to provide a method for deposition of the LFP cathode active materials on an aluminium foil current collector for lithium-ion (Li-ion) batteries by utilizing bio-degradable organic binders having low decomposition temperatures such as sodium carboxymethyl cellulose (Na-CMC), sodium poly acrylic acid (Na-PAA), sodium alginate (NA-ALG), and/or a combination thereof.

Yet another object of the embodiments herein is to provide a method for deposition of the LFP cathode active materials on an aluminium foil current collector for lithium-ion (Li-ion) batteries and characterization of the LFP films by the X-ray diffraction pattern.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide lithium iron phosphate (LFP) cathode active materials and a method for the preparation of the LFP cathode active materials for lithium-ion (Li-ion) batteries. A lithium-ion battery comprises an anode plate, a cathode plate, a separator between the anode plate and the cathode plate, and a non-aqueous electrolyte solution. The embodiments herein provide the fabrication of LFP cathode active materials for the cathode plate of Li-ion batteries using bio-degradable organic binders and solvents, and deposition of the cathode active materials on an aluminium foil current collector.

According to one embodiment herein, a lithium iron phosphate (LFP) cathode active material for lithium-ion (LI-ion) batteries is provided. The LFP cathode active material comprises nitrates of lithium, nitrates of iron, and phosphoric acid or dihydrogen ammonium phosphate as precursors. Further, the LFP cathode active material also comprises a water-soluble and low calorific value fuel and water. In addition, the LFP cathode active material comprises a water-soluble bio-degradable organic binder.

According to one embodiment herein, the concentration of precursors including nitrates of lithium is 0.383 g, nitrates of iron is 2.246 g, and the dihydrogen ammonium phosphate is 0.639 g. Besides, the concentration of water-soluble bio-degradable organic binder is 0.75 g.

According to one embodiment herein, the fuel used in LFP cathode active material comprises carbon, oxygen, nitrogen, and hydrogen. The hydrogen fuel comprises urea, citric acid, and/or glycine. Moreover, the most preferably used fuel in the LFP cathode active material is glycine, present at a concentration of 2.5 g, and also the calorific value of glycine is 3.24 kcal/g.

According to one embodiment herein, the water-soluble organic binder used in the LFP cathode active material comprises sodium carboxymethyl cellulose (Na-CMC), sodium poly acrylic acid (Na-PAA), sodium alginate (NA-ALG) and/or a combination thereof. Moreover, the organic binder has a low decomposition temperature in the range of 260 degrees Celsius to 280 degrees Celsius.

According to one embodiment herein, the theoretical specific capacity of the cathode active material is 170 mAh/g. The discharge potential of the cathode active material is in the range of 2.7 to 3.6 V. Furthermore, the cathode active material has a capacity retention of 93.3% after 450 to 500 cycles. Besides, the cathode active material is stable up to 220 degrees Celsius and starts degrading and reacting after 250 degrees Celsius.

According to one embodiment herein, the LFP cathode active material is further deposited on a conductive current collector. The conductive current collector is an aluminium foil current collector, and the cathode active material is deposited on the aluminium foil current collector using techniques, such as blade coating, slot-die coating, and/or screen printing. Blade coating is a popular thin-film fabrication technique that involves either running a blade over the substrate, such as aluminium, or moving a substrate underneath the blade. There is a small gap that determines how much solution, cathode active material can get through. Here, the solution is effectively spread over the substrate. Furthermore, the final thickness is a fraction of the gap between the substrate and the blade. Also, the final thickness of the wet film will be influenced by the viscoelastic properties of the solution and the speed of the coating. Blade coating is also known as doctor blading or knife coating. Furthermore, slot-die coating is a coating technique for the application of solution, slurry, or extruded thin films onto a substrate, such as glass, metal, paper, fabric, or plastic foils. The coating technique produces thin films via solution processing.

According to one embodiment herein, a method for the deposition of lithium iron phosphate (LFP) cathode active material for lithium-ion (Li-ion) batteries is provided. The method comprises procuring precursors including, nitrates of lithium, nitrates of iron, and phosphoric acid or dihydrogen ammonium phosphate. The method further involves procuring a water-soluble and low calorific value fuel to be mixed with the precursors. Furthermore, the method involves dissolving the precursors and the fuel in water separately followed by mixing the obtained solutions together, to obtain a redox mixture. The method further involves adding a bio-degradable organic binder, having a low decomposition temperature to the redox mixture, and stirring till a transparent thick gel-like substance is obtained, which is a particle-free slurry. In addition, the method involves coating the particle-free slurry on a conductive current collector using a deposition technique, to obtain a lithium iron phosphate (LFP) precursor. Furthermore, the method involves annealing the LFP precursor at a decomposition temperature of the organic binder under a reducing or inert atmosphere.

According to one embodiment herein, the concentration of precursors including nitrates of lithium is 0.383 g, nitrates of iron is 2.246 g, and the dihydrogen ammonium phosphate is 0.639 g. Also, the concentration of water-soluble bio-degradable organic binder is 0.75 g.

According to one embodiment herein, the fuel comprises carbon, oxygen, nitrogen, and hydrogen. Further, the hydrogen fuel comprises urea, citric acid, and/or glycine. Besides, the most preferably used fuel is glycine at a concentration of 2.5 g and the calorific value of glycine is 3.24 kcal/g.

According to one embodiment herein, the water-soluble organic binder includes sodium carboxymethyl cellulose (Na-CMC), sodium poly acrylic acid (Na-PAA), sodium alginate (NA-ALG), and/or a combination thereof. Further, the water-soluble organic binder has a low decomposition temperature in the range of 260 degrees Celsius to 280 degrees Celsius.

According to one embodiment herein, the redox mixture with the bio-degradable organic binder is stirred at a speed of 150 RPM to obtain the transparent thick gel-like substance, which is the particle-free slurry. Further, the time taken for the formation of particle-free slurry is 10 hours from the beginning stage/precursor stage.

According to one embodiment herein, the conductive current collector used for coating the particle-free slurry is an aluminium foil current collector. Moreover, the deposition technique to coat the particle-free slurry on the aluminium foil current collector includes blade coating, slot-die coating, and/or screen printing.

According to one embodiment herein, the decomposition temperature for annealing the LFP precursor of the organic binder is 400 degrees Celsius and the annealing of the LFP precursor is carried out for 3 hours. Furthermore, the reducing or inert atmosphere includes nitrogen or hydrogen atmosphere.

According to one embodiment herein, the theoretical specific capacity of the cathode active material is 170 mAh/g, and the discharge potential is in the range of 2.7 to 3.6 V. Moreover, the cathode active material is stable up to 220 degrees Celsius and starts degrading and reacting after 250 degrees Celsius.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the prior art in the form of a block diagram for the conventional fabrication method of LFP cathodes from the precursors for Li-ion batteries.

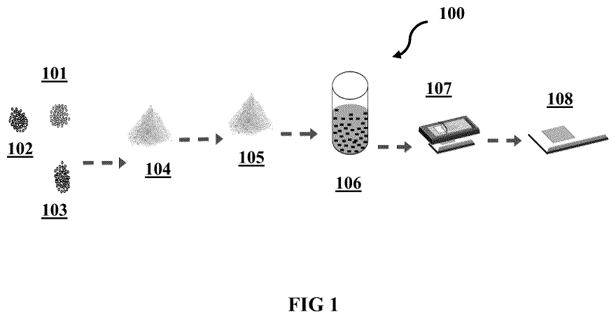

FIG. 2 illustrates the prior art as a flow chart for the conventional fabrication method of LFP cathodes from the precursors for Li-ion batteries.

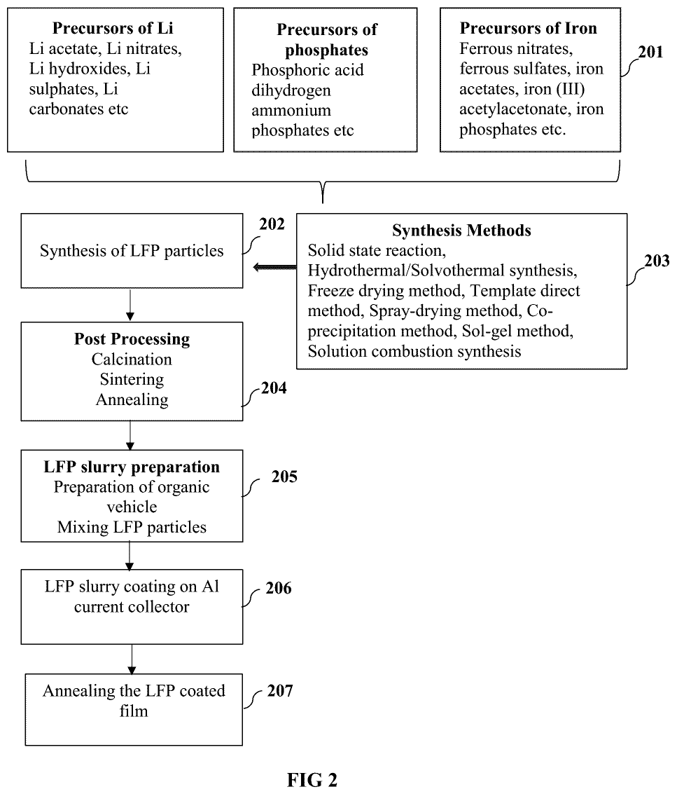

FIG. 3 illustrates a block diagram for the deposition/fabrication of LFP cathode active materials from precursors for lithium-ion (Li-ion) batteries, in accordance with an embodiment herein.

FIG. 4 illustrates a flowchart on a method for deposition/fabrication of LFP cathode active materials from precursors for lithium-ion (Li-ion) batteries, in accordance with an embodiment herein.

FIG. 5 illustrates a flowchart on a method for deposition/fabrication of LFP cathode active materials from precursors for lithium-ion (Li-ion) batteries as an example, in accordance with an embodiment herein.

FIG. 6 illustrates the X-ray diffraction pattern of LFP cathode materials on the aluminium (Al) current collector, in accordance with an embodiment herein.

Although the specific features of the present invention are shown in some drawings and not in others. This is done for convenience only as each feature may be combined with any or all of the other features in accordance with the present invention.

### Detailed Description of the Embodiments Herein

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The various embodiments herein provide lithium iron phosphate (LFP) cathode active materials and a method for the preparation of the LFP cathode active materials for lithium-ion (Li-ion) batteries. A lithium-ion battery comprises an anode plate, a cathode plate, a separator between the anode plate and the cathode plate, and a non-aqueous electrolyte solution. The embodiments herein provide the fabrication of LFP cathode active materials for the cathode plate of Li-ion batteries using bio-degradable organic binders and solvents, and deposition of the cathode active materials on an aluminium foil current collector.

According to one embodiment herein, a lithium iron phosphate (LFP) cathode active material for lithium-ion (LI-ion) batteries is provided. The LFP cathode active material comprises nitrates of lithium, nitrates of iron, and phosphoric acid or dihydrogen ammonium phosphate as precursors. Further, the LFP cathode active material also comprises a water-soluble and low calorific value fuel and water. In addition, the LFP cathode active material comprises a water-soluble bio-degradable organic binder.

According to one embodiment herein, the concentration of precursors including nitrates of lithium is 0.383 g, nitrates of iron is 2.246 g, and the dihydrogen ammonium phosphate is 0.639 g. Besides, the concentration of water-soluble bio-degradable organic binder is 0.75 g.

According to one embodiment herein, the fuel used in LFP cathode active material comprises carbon, oxygen, nitrogen, and hydrogen. The hydrogen fuel comprises urea, citric acid, and/or glycine. Moreover, the most preferably used fuel in the LFP cathode active material is glycine, present at a concentration of 2.5 g, and also the calorific value of glycine is 3.24 kcal/g.

According to one embodiment herein, the water-soluble organic binder used in the LFP cathode active material comprises sodium carboxymethyl cellulose (Na-CMC), sodium poly acrylic acid (Na-PAA), sodium alginate (NA-ALG) and/or a combination thereof. Moreover, the organic binder has a low decomposition temperature in the range of 260 degrees Celsius to 280 degrees Celsius.

According to one embodiment herein, the theoretical specific capacity of the cathode active material is 170 mAh/g. The discharge potential of the cathode active material is in the range of 2.7 to 3.6 V. Furthermore, the cathode active material has a capacity retention of 93.3% after 450 to 500 cycles. Besides, the cathode active material is stable up to 220 degrees Celsius and starts degrading and reacting after 250 degrees Celsius.

According to one embodiment herein, the LFP cathode active material is further deposited on a conductive current collector. The conductive current collector is an aluminium foil current collector, and the cathode active material is deposited on the aluminium foil current collector using techniques, such as blade coating, slot-die coating, and/or screen printing. Blade coating is a popular thin-film fabrication technique that involves either running a blade over the substrate, such as aluminium, or moving a substrate underneath the blade. There is a small gap that determines how much solution, cathode active material can get through. Here, the solution is effectively spread over the substrate. Furthermore, the final thickness is a fraction of the gap between the substrate and the blade. Also, the final thickness of the wet film will be influenced by the viscoelastic properties of the solution and the speed of the coating. Blade coating is also known as doctor blading or knife coating. Furthermore, slot-die coating is a coating technique for the application of solution, slurry, or extruded thin films onto a substrate, such as glass, metal, paper, fabric, or plastic foils. The coating technique produces thin films via solution processing.

According to one embodiment herein, a method for the deposition of lithium iron phosphate (LFP) cathode active material for lithium-ion (Li-ion) batteries is provided. The method comprises procuring precursors including, nitrates of lithium, nitrates of iron, and phosphoric acid or dihydrogen ammonium phosphate. The method further involves procuring a water-soluble and low calorific value fuel to be mixed with the precursors. Furthermore, the method involves dissolving the precursors and the fuel in water separately followed by mixing the obtained solutions together, to obtain a redox mixture. The method further involves adding a bio-degradable organic binder, having a low decomposition temperature to the redox mixture, and stirring till a transparent thick gel-like substance is obtained, which is a particle-free slurry. In addition, the method involves coating the particle-free slurry on a conductive current collector using a deposition technique, to obtain a lithium iron phosphate (LFP) precursor. Furthermore, the method involves annealing the LFP precursor at a decomposition temperature of the organic binder under a reducing or inert atmosphere.

According to one embodiment herein, the concentration of precursors including nitrates of lithium is 0.383 g, nitrates of iron is 2.246 g, and the dihydrogen ammonium phosphate is 0.639 g. Also, the concentration of water-soluble bio-degradable organic binder is 0.75 g.

According to one embodiment herein, the fuel comprises carbon, oxygen, nitrogen, and hydrogen. Further, the hydrogen fuel comprises urea, citric acid, and/or glycine. Besides, the most preferably used fuel is glycine at a concentration of 2.5 g and the calorific value of glycine is 3.24 kcal/g.

According to one embodiment herein, the water-soluble organic binder includes sodium carboxymethyl cellulose (Na-CMC), sodium poly acrylic acid (Na-PAA), sodium alginate (NA-ALG), and/or a combination thereof. Further, the water-soluble organic binder has a low decomposition temperature in the range of 260 degrees Celsius to 280 degrees Celsius.

According to one embodiment herein, the redox mixture with the bio-degradable organic binder is stirred at a speed of 150 RPM to obtain the transparent thick gel-like substance, which is the particle-free slurry. Further, the time taken for the formation of particle-free slurry is 10 hours from the beginning stage/precursor stage.

According to one embodiment herein, the conductive current collector used for coating the particle-free slurry is an aluminium foil current collector. Moreover, the deposition technique to coat the particle-free slurry on the aluminium foil current collector includes blade coating, slot-die coating, and/or screen printing.

According to one embodiment herein, the decomposition temperature for annealing the LFP precursor of the organic binder is 400 degrees Celsius and the annealing of the LFP precursor is carried out for 3 hours. Furthermore, the reducing or inert atmosphere includes nitrogen or hydrogen atmosphere.

According to one embodiment herein, the theoretical specific capacity of the cathode active material is 170 mAh/g, the discharge potential is in the range of 2.7 to 3.6 V. Moreover, the cathode active material is stable up to 220 degrees Celsius and starts degrading and reacting after 250 degrees Celsius.

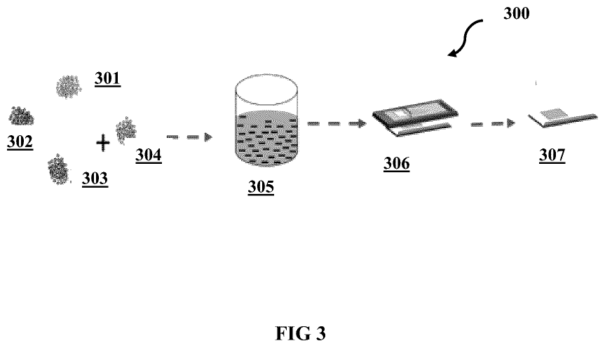

FIG. 3 illustrates a block diagram for the deposition/fabrication of LFP cathode active materials from precursors for lithium-ion (Li-ion) batteries, according to an embodiment herein. With respect to FIG. 3, 300 depicts the block diagram deposition/fabrication of LFP cathode active materials from precursors for lithium-ion (Li-ion) batteries. Initially, nitrates of lithium 301, nitrates of iron 302, and phosphoric acid or dihydrogen ammonium phosphates 303 are procured as the precursors. Besides, an appropriate fuel 304 with low calorific value and water solubility is chosen to be mixed with the precursors 301, 302, and 303. The fuel 304 includes urea, citric acid, and/or glycine. Furthermore, the precursors 301, 302, 303, and fuel 304 are mixed and dissolved in water to prepare a redox mixture. Further, a bio-degradable organic binder having low decomposition temperature is added to the redox mixture and stirred till a transparent thick gel-like substance called particle-free cathode slurry 305 is obtained. Further, the particle-free cathode slurry 305 is coated on an aluminum foil current collector 306 using an appropriate deposition method such as blade coating, slot-die coating, screen printing, etc., to obtain a LFP precursor film. Finally, annealing the LFP precursor film 307 at decomposition temperature, of the organic binder under reducing or inert atmosphere. The decomposition temperature is 400° C. and the inert atmosphere involves nitrogen or hydrogen atmosphere.

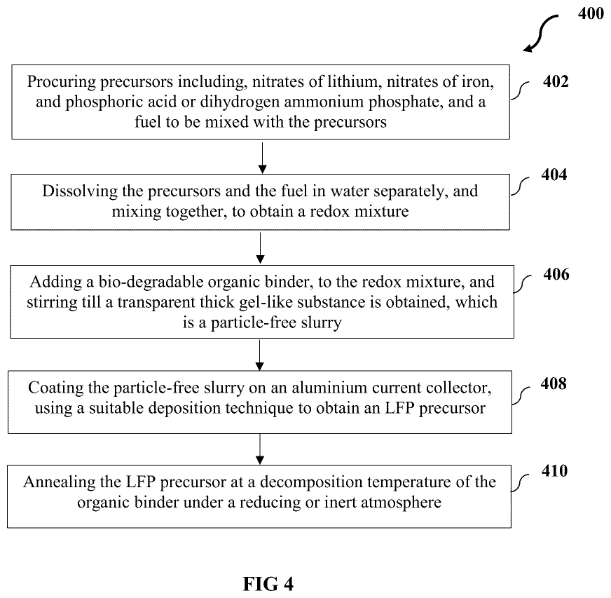

FIG. 4. illustrates a flowchart on a method for deposition/fabrication of LFP cathode active materials from precursors for lithium-ion (Li-ion) batteries, according to an embodiment herein. The method 400 comprises procuring precursors including, nitrates of lithium, nitrates of iron, and phosphoric acid or dihydrogen ammonium phosphate at step 402. The method 400 further involves procuring a water-soluble and low calorific value fuel to be mixed with the precursors at step 402. Furthermore, the method 400 involves dissolving the precursors and the fuel in water separately followed by mixing the obtained solutions together, to obtain a redox mixture at step 404. The method 400 further involves adding a bio-degradable organic binder, having a low decomposition temperature to the redox mixture, and stirring till a transparent thick gel-like substance is obtained, which is a particle-free slurry at step 406. In addition, the method 400 involves coating the particle-free slurry on a conductive current collector, such as an aluminium current collector, using a suitable deposition technique, such as blade coating, slot-die coating, screen printing, etc., to obtain a lithium iron phosphate (LFP) precursor at step 408. Furthermore, the method 400 involves annealing the LFP precursor at a decomposition temperature of the organic binder under a reducing or inert atmosphere at step 410. Hence, the method addresses the combustion chemistry of LFP precursor in which an exothermic reaction of the redox mixture releases enormous amount of heat that is utilized for the formation of LFP CAMs and incinerating the organic binders and solvents along with externally supplied heat during annealing giving the final film.

The embodiments herein may be more clearly understood with reference to the following example of the embodiments which are given by way of example only. One has to consider that the following example is included to demonstrate certain non-limiting aspects of the embodiments herein. It should be appreciated by those of skill in the art that the techniques disclosed in the example which follow represent techniques discovered by the inventor to function well in the practice of the invention. However, those of skilled in the art should, in light of the present disclosure, appreciate that many changes can be made in the specific embodiments which are disclosed and still obtain a like or similar result without departing from the spirit and scope of the invention.

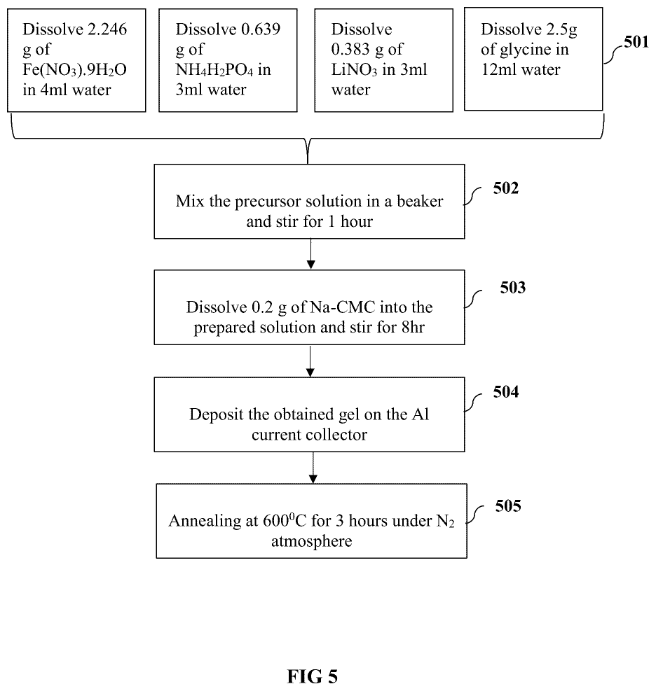

FIG. 5 illustrates a flowchart on a method for deposition/fabrication of LFP cathode active materials from precursors for lithium-ion (Li-ion) batteries as an example, according to an embodiment herein. The method 500 comprises at step 501, the precursors, such as 2.246 g of nitrates of iron (Fe(NO₃).9H₂O) in 4 ml of water, 0.639 g of dihydrogen ammonium phosphate (NH₄H₂PO₄) in 3 ml of water, 0.383 g of nitrate of lithium (LiNO₃) in 3 ml of water, and 2.5 g of glycine as fuel in 12 ml of water was procured. Further, at step 502, the precursor solutions were mixed in a beaker and stirred for 1 hour. In step 503, 0.2 gm of Na-carboxymethyl cellulose organic binder was added continuously into the obtained solution and stirred for 8 hours till a thick gel, which is a particle-free slurry was obtained. Furthermore, at step 504, the prepared particle-free slurry was deposited on an aluminum (Al) current collector through blade coating and a LFP precursor was obtained. Finally, at step 505, the LFP precursor was subjected to annealing at 600° C. for 3 hours under N₂ atmosphere the final film was obtained.

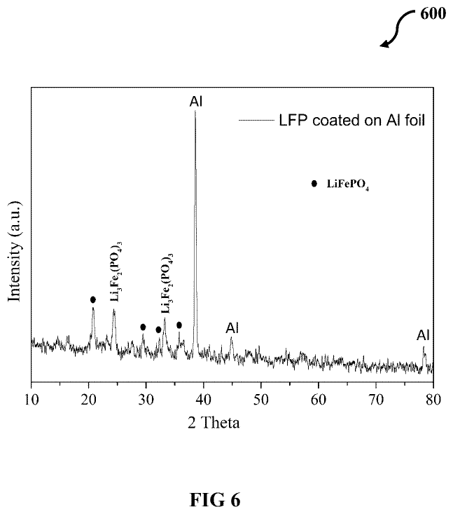

FIG. 6 illustrates the X-ray diffraction pattern of LFP cathode materials on an aluminium (Al) current collector, according to an embodiment herein. With respect to FIG. 6, 600 the LFP cathode materials on Al current collector is annealed at 600° C. for 3 hours under N₂ atmosphere and deposited as per the method 500 outlined in the FIG. 5. The XRD pattern 600 reveals that film is crystalline with distinct sharp peaks observed at 20.8°, 24.41°, 29.47°, 32.34°, 33.26°, 38.58°, 44.86°, and 78.31°. The peaks at 20.8°, 29.47°, and 32.34° confirm the formation of LiFePO₄ phase which is being used as CAMs or cathode active materials. Also, the XRD confirms the formation of the LFP cathodes on the aluminum current collector without the formation of secondary phases like Al₂O₃, etc. Some of the XRD peaks also reveal the presence of Li₃Fe₂(PO₄)₃ phase having a discharge potential of 2.8 V and theoretical specific capacity 120 mAhg⁻¹. The XRD peaks at 38.58°, 44.86°, and 78.31° represent the aluminum phase, informs that there is no oxidation of Al current collector on which the LFP precursor slurry is coated followed by annealing at elevated temperatures.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however that it is not intended to limit the disclosure to the forms disclosed, but on the contrary, the disclosure is to cover all modifications, equivalents, and alternatives falling within the scope of the disclosure.

The embodiments herein disclose a lithium iron phosphate (LFP) cathode active materials and a method for deposition of the LFP active materials on an aluminum-foil current collector for lithium-ion (Li-ion) batteries. The embodiments herein provides a simple and cost-effective method to develop eco-friendly LFP cathodes for Lithium-ion (Li-ion) batteries in high volume. More specifically, the embodiments herein details the method for the fabrication of LFP cathodes in high volume with less wastage of raw materials by bypassing and eliminating the steps involved in the conventional cathode fabrication method such as synthesis of cathode particles, post-processing activities (such as calcination, annealing) and preparation of slurry prior to the deposition on the aluminum current collector. Furthermore, the embodiments herein utilize bio-degradable and renewable organic binders and solvents in the processing of slurry, which enables the cathode manufacturing process to be less hazardous and clean as opposed to the methods existing in the literature. Moreover, the embodiments herein also reduce the wastage of raw materials and eliminate certain steps needed in the conventional method.

Moreover, the embodiments herein address the combustion chemistry of LFP precursor in which an exothermic reaction of the redox mixture releases an enormous amount of heat that is utilized for the formation of LFP CAMs and incineration of organic binders and solvents along with externally supplied heat during annealing. Therefore, the embodiments herein utilize chemicals having low decomposition temperatures, which results in the formation of required LFP CAMs in a short span with low energy. The embodiments herein, also further provide the usage of flora based cellulose organic binders and water as a solvent, which facilitates not only in cathode manufacturing but also in recycling part. Moreover, the entire fabrication process becomes faster as compared to conventional method as it reduces several steps used in between. Therefore, the entire process of the embodiments herein thus becomes simple, fast, cost-effective and environmental-friendly.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A lithium iron phosphate (LFP) cathode active material composition for lithium-ion batteries, comprising:
a. nitrates of lithium, nitrates of iron, and phosphoric acid or dihydrogen ammonium phosphate as precursors;
b. a water-soluble and low calorific value fuel and water; and
c. a water-soluble bio-degradable organic binder.

2. The cathode active material composition according to claim 1, wherein the concentration of precursors including nitrates of lithium is 0.383 g, nitrates of iron is 2.246 g, and the dihydrogen ammonium phosphate is 0.639 g; and wherein the concentration of water-soluble bio-degradable organic binder is 0.75 g.

3. The cathode active material composition according to claim 1, wherein the fuel comprises carbon, oxygen, nitrogen, and hydrogen; and wherein the hydrogen fuel comprises urea, citric acid, and/or glycine; and wherein the most preferably used fuel is the glycine at a concentration of 2.5 g and the calorific value of glycine is 3.24 kcal/g.

4. The cathode active material composition according to claim 1, wherein the water-soluble organic binder comprises sodium carboxymethyl cellulose (Na-CMC), sodium poly acrylic acid (Na-PAA), sodium alginate (NA-ALG) and/or a combination thereof; and wherein the water-soluble organic binder has a slow decomposition temperature in the range of 260 degrees Celsius to 280 degrees Celsius.

5. The cathode active material composition according to claim 1, wherein the specific capacity of the cathode active material is 170 mAh/g; and wherein the discharge potential of the cathode active material is in the range of 2.7 to 3.6 V; and wherein the cathode active material has a capacity retention of 93.3% after 450 to 500 cycles; and wherein the cathode active material is stable up to 220 degrees Celsius and starts degrading and react after 250 degrees Celsius.

6. The cathode active material composition according to claim 1, wherein the composition is deposited on a conductive current collector; and wherein the conductive current collector is an aluminium foil current collector; and wherein the cathode active material is deposited on the conductive current collector using techniques including blade coating, slot-die coating, and/or screen printing.

7. A method (400) for deposition of lithium iron phosphate (LFP) cathode active material composition for lithium-ion batteries, the method comprising steps of:
a. procuring precursors including, nitrates of lithium, nitrates of iron, and phosphoric acid or dihydrogen ammonium phosphate (402);
b. procuring a water-soluble and low calorific value fuel to be mixed with the precursors (402);
c. dissolving the precursors and the fuel in water separately followed by mixing the obtained solutions together, to obtain a redox mixture (404);
d. adding a bio-degradable organic binder, having a low decomposition temperature to the redox mixture and stirring till a transparent thick gel-like substance is obtained, which is a particle-free slurry (406);
e. coating the particle-free slurry on a conductive current collector using a deposition technique, to obtain a lithium iron phosphate (LFP) precursor (408); and
f. annealing the LFP precursor at a decomposition temperature of the organic binder under a reducing or inert atmosphere (410).

8. The method (400) according to claim 7, wherein the concentration of precursors including nitrates of lithium is 0.383 g, nitrates of iron is 2.246 g, and the dihydrogen ammonium phosphate is 0.639 g; and wherein the concentration of water-soluble bio-degradable organic binder is 0.75 g.

9. The method (400) according to claim 7, wherein the fuel comprises carbon, oxygen, nitrogen, and hydrogen; and wherein the hydrogen fuel comprises urea, citric acid, and/or glycine; and wherein the most preferably used fuel is the glycine at a concentration of 2.5 g and the calorific value of glycine is 3.24 kcal/g.

10. The method (400) according to claim 7, wherein the water-soluble organic binder comprises sodium carboxymethyl cellulose (Na-CMC), sodium poly acrylic acid (Na-PAA), sodium alginate (NA-ALG) and/or a combination thereof; and wherein the water-soluble organic binder has low decomposition temperature in the range of 260 degrees Celsius to 280 degrees Celsius.

11. The method (400) according to claim 7, wherein the redox mixture with the bio-degradable organic binder is stirred at a speed of 150 RPM to obtain the transparent thick gel-like substance, the particle-free slurry; and wherein the time taken for the formation of particle-free slurry is 10 hours from the beginning stage.

12. The method (400) according to claim 7, wherein the conductive current collector is an aluminium foil current collector; and wherein the deposition technique to coat the particle-free slurry on the aluminium foil current collector includes blade coating, slot-die coating, and/or screen printing.

13. The method (400) according to claim 7, wherein the decomposition temperature for annealing the LFP precursor of organic binder is 400 degrees Celsius; and wherein annealing the LFP precursor is carried out for 3 hours; and wherein the reducing or inert atmosphere includes nitrogen or hydrogen atmosphere.

14. The method (400) according to claim 7, wherein the specific capacity of the cathode active material is 170 mAh/g; and wherein the discharge potential of the cathode active material is in the range of 2.7 to 3.6 V; and wherein the cathode active material has capacity retention of 93.3% after 450 to 500 cycles; and wherein the cathode active material is stable up to 220 degrees Celsius and starts degrading and react after 250 degrees Celsius.
